(19) United States
(12) Patent Application Publication
(10) Pub. No.: US 2017/0235882 A1
(43) Pub. Date: Aug. 17, 2017

(54) CONDITION MANAGEMENT SYSTEM AND METHOD

(71) Applicant: mHealthPharma, Inc., New York, NY (US)

(72) Inventors: Steven Orlov, Toronto (CA); Leonid Orlov, Sherman Oaks, CA (US); Alexander Berlin, Katonah, NY (US)

(21) Appl. No.: 15/044,572

(22) Filed: Feb. 16, 2016

(51) Int. Cl. G06F 19/00; G06Q 10/10; H04L 29/06

(52) U.S. Cl. CPC G06F 19/322; G06F 19/3406; G06F 19/3431; G06F 19/345; H04L 63/10; G06Q 10/105

(57) ABSTRACT

A medical condition management system includes at least one server including at least one database including a patient record, and at least one processor coupled to the at least one database, a patient device in operable communication with the at least one server, the patient device including a patient application, the patient device operable by a patient user, and a medical professional device in operable communication with the at least one server, the medical professional device including a medical professional application, the medical professional device operable by a medical professional user. The processor is configured to perform a comparison of provided biometric information with provided recommendation information and to determine whether a notification is necessary based on the comparison and the server is configured to send the notification to at least one of the patient device and the medical professional device if the processor determines that the notification is necessary.

### FIELD OF THE TECHNOLOGY

The subject matter disclosed herein relates generally to condition management. More particularly, the subject matter relates to a condition and/or disease management system that utilizes data collection and analyzes collected data related to a patient.

### BACKGROUND

Present conventional management of human conditions such as chronic diseases relies on periodic clinical assessments of a patient's condition and/or disease status by a medical professional such as a doctor, nurse, or nurse practitioner. This occurs during clinical visits or follow-up appointments that take place several weeks or months apart. During these visits, biometric data is conventionally collected professionally and used to render recommendations by a medical professional regarding appropriate treatment. In most cases this treatment takes the form of prescription medications. Patients are encouraged to monitor their own disease activity between clinical visits (i.e. at home) but any information gathered by self-monitoring by patients is not consistently communicated to the medical professional and does not result in timely changes to the patient's treatment plan. Rather, patients inconsistently share their home monitoring results with their medical professionals during follow-up visits. However, the majority of clinical decision making is based on the instantaneous assessment of disease activity during the clinical visit despite any home monitoring conducted by the patient.

Still further, conventional systems exist whereby a user operated device is configured to provide biometric data to a computer or server within the system. For example, a wristwatch may be configured to provide biometric data of a user (i.e. pulse, sleep duration, etc). The computer or server may receive the biometric data and output notifications back to the user operated device. However, in these conventional systems, there is no doctor-patient interaction. Further, in these conventional systems, a doctor cannot tailor the output from the computer or server based on the doctor's first-hand knowledge of the patient. Thus, existing systems simply provide analysis or information to a user based on the input of biometric information that the computer or server receives from the user.

Thus, an improved disease and/or condition management system based on data collection and analysis of collected data related to a patient that incorporates doctor input, analysis, feedback, and/or instruction would be well received in the art.

### BRIEF DESCRIPTION

According to one aspect, a medical condition management system comprises: at least one server including: at least one database including a patient record; at least one processor coupled to the at least one database; a patient device in operable communication with the at least one server, the patient device including a patient application, the patient device operable by a patient user; a medical professional device in operable communication with the at least one server, the medical professional device including a medical professional application, the medical professional device operable by a medical professional user, wherein the patient application is configured to allow the patient user to provide biometric information to the patient record, wherein the at least one database is configured to store the provided biometric information in the patient record, wherein the medical professional application is configured to provide the medical professional user with access to the biometric information, wherein the medical professional application is configured to allow the medical professional user to provide recommendation information to the patient record, wherein the at least one database is configured to store the provided recommendation information in the patient record, wherein the patient application is configured to allow the patient user to access the recommendation information, wherein the at least one processor is configured to perform a comparison of the biometric information and the recommendation information, wherein the at least one processor is configured to determine whether a notification is necessary based on the comparison of the biometric information and the recommendation information, and wherein the at least one server is configured to send the notification to at least one of the patient device and the medical professional device if the at least one processor determines that the notification is necessary.

According to another aspect, a method of managing a medical condition of a patient comprises: providing a medical condition management system including: at least one server including: at least one database including a patient record; at least one processor coupled to the at least one database; a patient device in operable communication with the at least one server, the patient device including a patient application, the patient device operable by a patient user; a medical professional device in operable communication with the at least one server, the medical professional device including a medical professional application, the medical professional device operable by a medical professional user; allowing, by the patient application, the patient user to provide biometric information to the patient record; storing, by the at least one database, the provided biometric information in the patient record; providing, by the medical professional application, the medical professional user with access to the biometric information; allowing, by the medical professional application, the medical professional user to provide recommendation information to the patient record; storing, by the at least one database, the provided recommendation information in the patient record; allowing, by the patient application, the patient user to access the recommendation information; performing, by the at least one processor, a comparison of the biometric information and the recommendation information; determining, by the at least one processor, whether a notification is necessary based on the comparison of the biometric information and the recommendation information; and sending, by the at least one server, the notification to at least one of the patient device and the medical professional device if the at least one processor determines that the notification is necessary.

According to another aspect, a computer program product, comprises a computer readable hardware storage device storing a computer readable program code, said computer readable program code comprising an algorithm that, when executed by at least one computer processor connected to at least one database and connected to a patient device operated by a patient user and a medical professional device operated by a medical professional user, implements a method of managing a medical condition of a patient comprising: receiving, by the at least one computer processor, biometric information related to a medical condition of the patient user from the patient device; storing, by the at least one computer processor, the provided biometric information in a patient record of the at least one database; providing, by the at least one computer processor, the medical professional user with access to the biometric information; receiving, by the at least one computer processor, recommendation information related to a patient recommendation for the patient user from the medical professional device; storing, by the at least one computer processor, the provided recommendation information in the patient record of the at least one database; providing, by the at least one computer processor, the patient user with access the recommendation information; performing, by the at least one computer processor, a comparison of the patient related information and the recommendation information; determining, by the at least one computer processor, whether a notification is necessary based on the comparison of the biometric information and the recommendation information; and sending, by the at least one computer processor, the notification to at least one of the patient device and the medical professional device if the at least one computer processor determines that the notification is necessary.

### BRIEF DESCRIPTION OF THE DRAWINGS

The subject matter that is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 depicts a schematic view of a condition management system in accordance with one embodiment;

FIG. 2 depicts a patient record of the condition management system of FIG. 1 in accordance with one embodiment;

FIG. 3 depicts a permission information location of a database of the condition management system of FIG. 1 in accordance with one embodiment;

FIG. 4 depicts an embodiment of a server of the condition management system of FIG. 1 in accordance with one embodiment; and

FIG. 5 depicts a method of managing a medical condition in accordance with one embodiment;

FIG. 6 depicts a method of managing a medical condition in accordance with another embodiment; and

FIG. 7 depicts a computer system of the condition management system in accordance with one embodiment.

### DETAILED DESCRIPTION

A detailed description of the hereinafter described embodiments of the disclosed apparatus and method are presented herein by way of exemplification and not limitation with reference to the Figures.

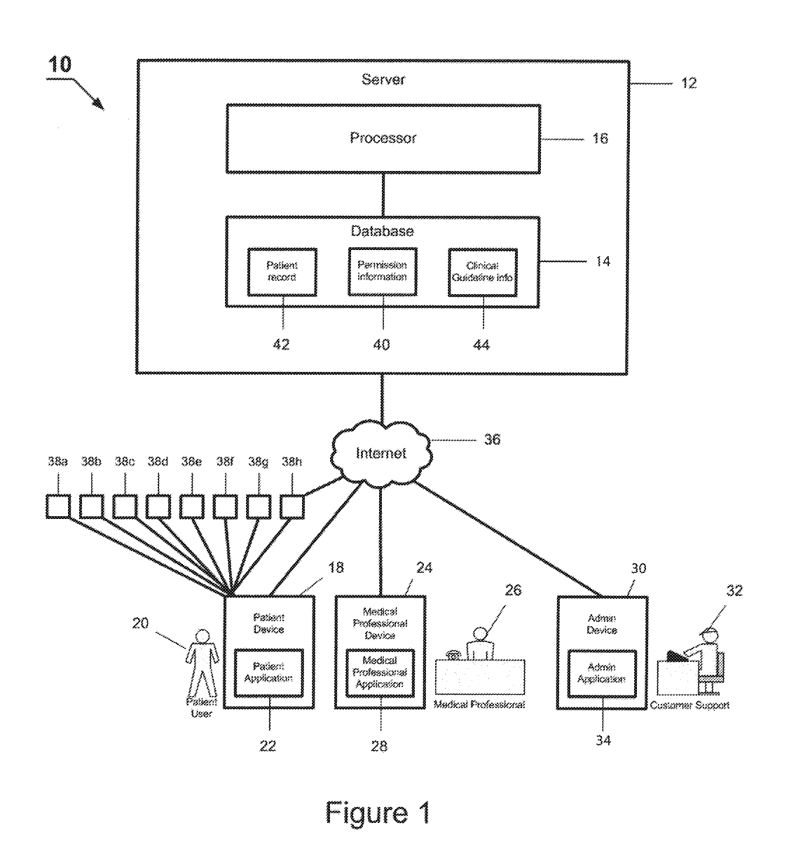

Referring to FIG. 1, a condition management system 10 is shown in accordance with one embodiment. The condition management system 10 may be configured to manage conditions such as chronic diseases or conditions such as hypertension, diabetes, heart disease, obesity, tobacco use related conditions, eating disorders, chronic obstructive pulmonary disease, cancer, ALS, Alzheimers, dementia, cancer, osteoporosis, coronary artery disease, sleep apnea, thyroid disease, and the like. It should be understood that the condition management system 10 may facilitate managing any type of medical condition and/or disease that may be experienced by a human patient.

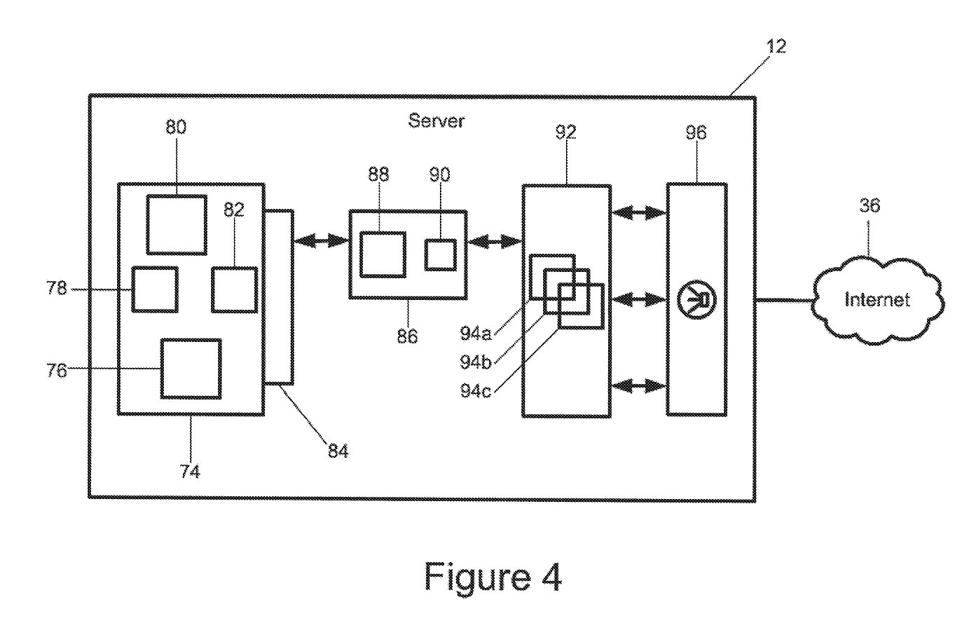

The condition management system 10 is shown having a server 12. It should be understood that the server 12 shown in FIG. 1 may be one or more servers and that hereinafter “the server” means at least one server. For example, the methods and capabilities described herein may be hosted, processed, ran, or otherwise performed by a plurality of connected servers. The server 12 may include a database 14 or other file storage location. The database 14 may be one or more databases, and may include a plurality of connected databases for storing information and data in the condition management system. Hereinafter “the database” means at least one database. Still further, the server 12 may include a processor 16 coupled or otherwise connected to the database 14. The processor 16 may be one or more computer processors capable of processing data and performing the methods and capabilities described herein and hereinafter, “the processor” means at least one processor. An example of the server 12 is shown including a plurality of servers and various additional features in the embodiment depicted in FIG. 4, described hereinbelow.

A patient device 18 may further be included in the condition management system 10 in operable communication or otherwise connected with the server 12 such that data may be transferred between the patient device 18 and the server 12. The patient device 18 may be a mobile device such as a cell phone, laptop, or tablet device. In other embodiments, the patient device 18 may be a desktop computer, a laptop computer or the like. The patient device 18 may include a computer processor, a data storage location, and the like. The patient device 18 may be operated, owned, or otherwise used by a patient user 20. The patient user may be a medical patient that may be being treated by medical professionals for a condition such as a chronic disease or the like. The patient device 18 may include a patient application 22 running or otherwise operable on the patient device 18. The patient application 22 may be an application operable on the patient device 18 configured to perform the functionality described herein. The patient application 22 may be configured to allow for the patient user 20 to login using a name and/or password or other credentials that are specific to the patient user 20.

A medical professional device 24 may further be included in the condition management system 10 in operable communication or otherwise connected with the server 12 such that data may be transferred between the medical professional device 24 and the server 12. The medical professional device 24 may be a mobile device such as a cell phone, laptop, or tablet device. In other embodiments, the medical professional device 24 may be a desktop computer, a laptop computer or the like. The medical professional device 24 may include a computer processor, a data storage location, and the like. The medical professional device 24 may be operated, owned, or otherwise used by a medical professional user 26. The medical professional user 26 may be a doctor, a dentist, a nurse practitioner, a nurse or the like. The medical professional device 18 may include a medical professional application 28 running or otherwise operable on the medical professional device 24. The medical professional application 28 may be an application operable on the medical professional device 24 configured to perform the functionality described herein. The medical professional application 28 may be configured to allow for the medical professional user 26 to login using a name and/or password or other credentials that are specific to the medical professional user 26.

An administrator device 30 may further be included in the condition management system 10 in operable communication or otherwise connected with the server 12 such that data may be transferred between the administrator device 30 and the server 12. The administrator device 30 may be a mobile device such as a cell phone, laptop, or tablet device. In other embodiments, the administrator device 30 may be a desktop computer, a laptop computer or the like. The administrator device 30 may include a computer processor, a data storage location, and the like. The administrator device 30 may be operated, owned, or otherwise used by an administrator user 32. The administrator user 32 may be a network administrator, a customer support specialist, a software specialist, or the like. The administrator device 30 may include an administrator application 34 running or otherwise operable on the administrator device 30. The administrator application 34 may be an application operable on the administrator device 30 configured to perform the functionality described herein. The administrator application 34 may be configured to allow for the administrator user 32 to login using a name and/or password or other credentials that are specific to the administrator user 32.

The patient device 18, the medical professional device 24, and the administrator device 30 may be connected to the server 12 over the internet 36. In other embodiments, one or more of the patient device 18, the medical professional device 24, and the administrator device 30 may be directly connected to one or more of the server 12. In other words, at least one of the patient device 18, the medical professional device 24, and the administrator device 30 may be part of the same local network with the server 12 (or at least one of the servers from the at least one server 12 in the event that the server 12 is a plurality of servers), in some embodiments. For example, the administrator device 30 may, for example, be directly connected to the server 12, the processor 16, and the database 14 in one embodiment.

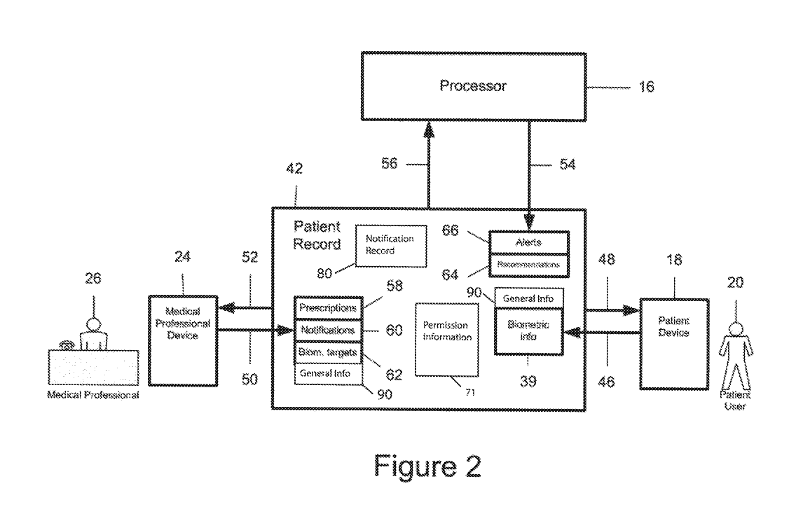

The condition management system 10 may further include at least one information gathering device 38a, 38b, 38c, 38d, 38e, 38f, 38g. The information gathering device 38a, 38b, 38c, 38d, 38e, 38f, 38g may be configured to obtain biometric information 39 (shown in FIG. 2) from the patient user 20 and facilitate in providing the biometric information 39 to the server 12. The information gathering device may be a scale 38a, a blood pressure measuring device 38b, a glucose measuring device 38c, a sleep measuring device 38d, a heart monitoring device 38e, a lung function measuring device 38f and/or a wearable device 38g. In other embodiments, the information gathering device may be a carry-able mobile device 38h. The information gathering device 38a, 38b, 38c, 38d, 38e, 38f, 38g, 38h may be operable by, or otherwise interacted with by the patient user 20 in order to receive, gather or obtain information relating to biometrics or biometric measurements taken by the patient user 20. Hereinafter, “the information gathering device 38” may refer to one, a plurality of, or all of the example devices 38a, 38b, 38c, 38d, 38e, 38f, 38g, or any other device that is configured to take or obtain biometric measurements from a person.

The patient application 22 may be configured to allow the patient user 20 to provide biometric information 39 related to a medical condition of the patient user 20 to a patient record 42 located in the database 14. The biometric information 39 may be actual biometric levels such as blood pressure levels, body temperature levels, weight levels, heart rate levels, glucose levels, spirometry levels, sleep duration levels, and the like. Thus, the biometric information 39 may be any biometric measurements, biometrics or other data relating to the physiological condition of the patient. Additionally, the biometric information may be related to the historical aggregate of a given dataset. For example, the biometric information may include the number of steps a person walked in a given time period. In one embodiment, the patient application 22 may include a user interface that allows a user to manually input biometric information 39. The patient application 22 and/or the patient device 18 may then be configured to send the biometric information 39 to the server 12 over the internet 36, for example. In one embodiment, the patient may be required to review and actively send information to the server 12. In this embodiment, a confirmation may be required to be input by the patient user 20 for the biometric information 39 to be sent to the server 12. In another embodiment, the biometric information 39 may be sent to the server 12 automatically and immediately upon being entered by the patient user 20.

The biometric information 39 may further be provided or sent to the server 12 directly by the information gathering device 38 over the internet 36. In other embodiments, the information gathering device 38 may be connected to the patient device 18 and may provide the biometric information 39 to the patient device 18 for processing through the patient application 22. For example, the information gathering device 38 may take biometric measurements in order to obtain the biometric information 39 and may send the biometric information 39 to the patient device 22, which may be configured to display the taken biometric information 39 through the patient application 22 running on the patient device 18. Once received by the patient application 22 by the information gathering device 38, the biometric information 39 may be thereafter sent to the server 12 by the patient application 22, either automatically or after confirmation has been received by the patient user 20. In one embodiment, the patient device 18 and the information gathering device 38 may be connected via a Bluetooth link or the like in order for the information gathering device 38 to immediately provide gathered information and measurements to the patient device 18 and stored locally on the patient device 18 by the patient application 22 prior to being sent to the server 12. Once being received by the patient device 18 from the information gathering device 38, the biometric information 39 may thereafter or immediately be provided by the patient application 22 and/or the patient device 18 to the server 12.

The patient device 18 shown in FIG. 1 may include or comprise a plurality of devices that are operable by the patient user 20, each having an installed version of the patient application 22 operable on the respective device. These respective devices may each be operated separately by the patient user 20 and may or may not be running simultaneously. For example, the patient user 20 may own, operate or otherwise use a mobile phone, a tablet, and a desktop computer. Each of these three patient devices may include the patient application 22 installed and operable thereon.

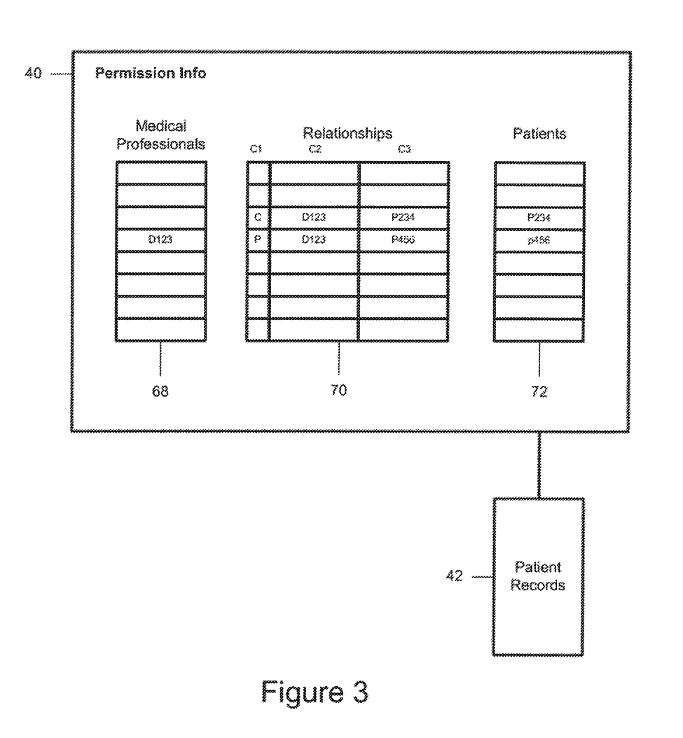

The patient application 22 may be configured to request the patient user 20 to provide log-in credentials on the specific patient device 18 being used. These log-in credentials may be reviewed by the server 12 and/or the processor 16 before the server 12 will begin to accept biometric information 39 from the respective patient device being operated by the patient user 20, or before the patient user 20 is able to otherwise interact with the patient application 22 on the patient device 18. Log-in credentials may be stored on the database 14 either in the patient record 42 or at another appropriate data storage location (i.e. a location for permission information 40 to be stored, described hereinbelow and shown more particularly in FIG. 3).

Additionally, the log-in credentials may be stored when the patient user 20 creates an account. The creation of an account for the patient user 20 may be created automatically by the customer support user 32 or other back end network administrator or the like. Alternatively, the creation of an account of the patient user 20 may be done by the patient user 20 downloading, installing and running the patient application 22 on the patient device 18 and creating an account with an account creation interface of the patient application 22. The account creation by the patient user 20 may require credential information provided to the patient user 20 by their medical professional 26, a representative from the medical insurance company used by the patient user 20, or the like.

Thus, each of the mobile phone, the tablet and the desktop computer may be required to be connected to the server 12 during login in order to verify that the patient user 20 and the patient device 18 currently being used by the patient user 20 is recognized by the server 12. This recognition by the server 12 may connect the respective patient device 18 to the particular patient record 42 associated with the patient user 20. The condition management system 10 may be configured to operable with a large number of patient users 20, each having their own separate and individual patient record 42. Once connected in this manner and after log-in credentials have been provided by the patient user 20 into the patient application 20, the patient device 18 may send the biometric information 39 to the particular patient record 42 associated with the patient user 20 in the database 14.

In another embodiment, the patient device 18 and the information gathering device 38 may be a single device that includes the functionality of each of the patient device 18 and the information gathering device 38 described herein. For example, the patient application 22 may be running or operable on the information gathering device 38 described hereinabove. For example, the wearable device 38g may include a user interface or screen that allows a user to interact with the wearable device 38g and run the patient application 22 to perform the functionality described hereinabove. The wearable device 38g may be configured to passively gather the biometric information 39 from the patient user 20 while the wearable device 38g is being worn by the patient user 20. This biometric information 39 may be displayed on a display of the wearable device 38g and the patient application 22 may allow the patient user 20 to send this biometric information 39 to the server 12. Alternatively, the biometric information 39 passively gathered by the wearable device 38g may be automatically and immediately provided to the server 12 without the need for the patient user 20 to actively send the biometric information 39 to the server 12. Any of the exemplary information gathering devices 38 described hereinabove may include a user interface, display and/or processor such that the information gathering device 38 may include the functionality of the patient device 18 described herein.

The automatic and immediate providing of the biometric information 39 to the server 12 by the patient user 20 may be a setting within the patient application 22 that may be activated by the patient user 20. For example, the patient application 22 may require confirmation from the patient user 20 before any biometric information 39 is sent from the patient device 18 to the server 12. However, the patient user 20 may toggle a setting whereby some or all of the collected or entered biometric information 39 may be automatically sent from the patient device 18 to the server 12.

In one embodiment, the patient device 18 may be a mobile phone with a gyroscopic element that is configured to determine how many steps the patient user 20 takes in a given period of time, how many miles the patient user 20 walks in a given period of time, or the like. In this embodiment, the patient device 18 may also simultaneously act as the information gathering device 38h. The biometric information 39 related to the steps a user has taken, for example, may be provided, using the patient application 22, to the server 12 in the manner described hereinabove.

The patient application 22 may operate on the patient device 18 running in the background of a computer operating system at all times once the patient application 22 is initiated or executed by the patient device 18. In this embodiment, a connection may be retained during the operation of the patient application 22 between the server 12 and the patient device 18. This may facilitate the patient device 18 being configured to constantly, automatically and immediately provide updated biometric information 39 as the patient device 18 receives the biometric information 39 from the patient user 20 or gathers the information (in the event that the patient device 18 is the information gathering device 38).

For example, the patient user 20 may interact with the scale 38a or other information gathering device in the usual manner in order to take a biometric measurement (i.e. to take a weight measurement in the case of the scale 38a) of the patient user 20. The scale 38a or other information gathering device 38 may be connected to the patient device 18, such as the mobile phone of the patient user 20, via a Bluetooth connection. Each time the patient user 20 takes the biometric measurement on the scale 38a or other information gathering device 38, the information obtained by the scale 38a or other information gathering device 38 may be transmitted by the scale 38a or other information gathering device 38, using a data transmitter, to the patient device 18. The patient device, while running the patient application 22, may receive the biometric information 39 from the scale 38a or other information gathering device 38 and may automatically (or with confirmation from the patient user 20) provide this information to the server 12.

In another embodiment, the patient device 18 may not be on, or the patient application 22 may not be running at the time that the patient user 20 takes their biometric measurement on the scale 38a or other information gathering device 38. In this embodiment, the scale 38a or other information gathering device 38 may be configured to notify the patient user 20 to turn on the application on their patient device 20 to establish a connection with the patient device 20 prior to taking their biometric measurement. This warning that the scale 38a or other information gathering device 38 is not connected to the patient device 18 may be provided on a display or with an LED or the like found on the scale 38a or other information gathering device 38. In another embodiment, if the scale 38a or other information gathering device 38 may be configured to save any biometric measurements taken when no connection is established with the patient device 18 running the patient application 22. In other embodiments, the scale 38a or other information gathering device 38 may be directly connected to the internet 36 and may thereby be recognized by the server 12 as a device that provides the biometric information 39 to the server 12. This may require that the patient user 20 to enter confirmation or log-in credential information with an interface found on the scale 38a or other information gathering device 38 in order to register the scale 38a or other information gathering device 38 with the server 12 so that the server associates biometric information 39 being provided by the scale 38a or other information gathering device 38 with the proper patient record 42. It should be understood that the embodiments described hereinabove with respect to the scale may be similarly applicable to the blood pressure measuring device 38b, the glucose measuring device 38c, the sleep measuring device 38d, the heart monitoring device 38e, the lung function measuring device 38f, the wearable device 38g and the carry-able mobile device 38h.

Referring now to FIG. 2, upon being received by the server 12, via a communication 46, the database 14 may be configured to store the biometric information 39 to the patient record 42. In one embodiment, the biometric information 39 may be first provided to the processor 16. The processor 16 may be configured to process the received biometric information 39 and then provide the biometric information 39 to the proper patient record 42 associated with the patient user 20 that sent the biometric information 39.

Referring back to FIG. 1, the system 10 further may include the medical professional application 28 operable on a medical professional device 24 by a medical professional user 26. The medical professional application 28 may require the medical professional user 26 to create an account and log-in using credentials in a similar manner to the patient user 20 as described hereinabove in order to connect to the server 12 and the database 14. The medical professional application 28 may be configured to provide the medical professional user 26 with access to the biometric information 39 stored in the patient record 42 if the patient user 20 has provided the medical professional user 26 with permission. Access to the individual patient records 42 in this manner may be provided by permission information 40 which may be stored in a particular location in the database 14.

FIG. 3 shows an embodiment of the permission information 40 that may be stored in the database 14. In this embodiment, a medical professional D1 may connect to the condition management system 10 and/or the server 12. The medical professional D1 accounts within the condition management system 10 may be found in a first location 68 of the database 14. Similarly, the embodiment shows patient accounts P1 and P2 within a second location 72 of the database 14. The condition management system 10 may further keep track of the physician-patient relationship in a third location 70 of the database 14. This third location 70 is shown having a first column C1, a second column C2, and a third column C3. The first column C1 retains information relating to the status of a relationship between a patient user and a medical professional user. The second and third columns C2, C3 represent the two individuals that may be included in the relationship. This relationship may be identified, for example, by a “C” which represents a “Confirmed” relationship, or a “P” which represents a “Pending” relationship. A “Pending” relationship may exist when one of the medical professional D1 or the patient account P1 requests permission to share information with the other respective account, but the other account has not yet confirmed the relationship. A “Pending” relationship may not provide either user in the relationship with access to the patient record 42 of the patient account P1 or privileged information available to the patient P1 from the medical professional D1 that would otherwise be available if the relationship was “confirmed.” It should be understood that the embodiment shown in FIG. 3 is exemplary and that other forms of permission information storage and processing are contemplated.

In practice, the medical professional user 26 may look up a patient user account P1 (for example), using the medical professional application 28, by the name, date of birth, email address or any other information that the patient user 20 may provide publicly using the patient application 22. Alternatively, the patient user 20 may look up a medical professional user account D1 (for example), using the patient application 22, by the medical name, email address or any other information that the medical professional user 26 may provide publicly using the medical professional application 28. One or the other of the medical professional user 26 and the patient user 20 may initiate a request to establish a medical professional-patient relationship (i.e. a physician or doctor-patient relationship) using an interface provided by either the medical professional application 28 (in the case of the medical professional user 26) or the patient application 22 (in the case of the patient user 20). The other of the two may then confirm this relationship using their respective application. The condition management system 10 and/or the server 12 may record this information (pending and confirmed relationships) in the manner shown in FIG. 3. In the event that a permission request is rejected by one or the other party, the request status may be removed from the third location 70. Each of the confirmed relationships that the patient user 20 has acquired may be stored in the patient record 42 of the patient user as well as any other appropriate location for storing permission information 71 in the database 14. It should be understood that while the permission information 71 is shown in the patient record 42 in FIG. 2 that the permission information 71 may also be stored outside the patient record 42 at another permission information location 40 in the database 14. Once it has been confirmed that a relationship exists between the medical professional user 26 and the patient user 20, the medical professional user 26 may be provide access with the information found in the patient user's individual patient record 42. Thus, the permission information 71 may determine whether the patient user 20 has access to information (such as recommendation information 58, 60, 62 described hereinbelow) and the permission information 71 may further determine whether the medical professional user 26 has access to the biometric information 39 and other patient information found in the patient record 42. Further, the patient application 22 may provide the patient user 20 with control over whether any other user, such as the medical professional user 26 or customer support user 32 have access to the provided biometric information 39 and other patient information found in the patient record 42. Similarly, the medical professional application 28 may provide the medical professional user 26 with control over whether any other user, such as the patient user 20 or customer support user 32 have access to certain information provided to the system by the medical professional user 26.

The medical professional application 28 may include an interface that is configured to allow the medical professional user 26 to provide recommendation information related to a patient recommendation for the patient user 20 to the patient record 42 once a relationship has been established between the medical professional user 26 and the patient user 20 as described hereinabove. Shown in FIG. 2, recommendation information may take various forms such as prescription recommendations 58 (i.e. once per day, twice per day or the like), biometric target range recommendations 62, and notification settings 60.

The medical professional application 28 may include an interface configured to allow the medical professional 26 to provide recommendations to the patient user 20 to take prescriptions, such as a prescription recommendation 58. This information may be used by the server 12 in order to make a determination if sending a notification to the patient user 20 is necessary. The medical professional 26 may input a prescription recommendation 58 related to scheduling targets for taking a biometric measurement by the patient user 20 and providing the actual biometric level to the server 12. This prescription recommendation 58 may require the patient user 20 to take a biometric measurement and obtain an actual biometric level on a daily basis. For example, the medical professional 26 may include a prescription for a patient user 20 to take a blood pressure reading once per day and input the result into the patient record 42 in one of the manners described hereinabove.

Similarly, the medical professional may provide a prescription recommendation 58 for the patient user 20 to take a medication once per day. The patient application 22 may thereafter request for the patient user to confirm when the prescription has been taken. The patient application 22 may be configured to allow a patient to confirm that the medication has been taken by allowing the patient to enter a manual input that provides this confirmation.

The medical professional application 28 may further include an interface configured to allow the medical professional 26 to provide biometric target ranges 62. For example, the medical professional may provide specific target ranges relating to blood pressure, sleep duration, weight, distance traveled by walking per day, glucose levels, or the like. The biometric target ranges 62 may include a lower and an upper bound (i.e. a target no lower than X but no higher than Y). In other embodiments, the biometric target ranges 62 may only include an upper bound (i.e. a target no higher than Z). Still further, the biometric target ranges 62 may include only a lower bound (i.e. a target no lower than W). The biometric target ranges 62 may include, for example, blood pressure ranges, body temperature ranges, weight ranges, heart rate ranges, glucose level ranges, spirometry level ranges, and sleep duration ranges. Still further, the target ranges 62 may not be a range, but may be one or more specific numbers.

The medical professional application 28 may further include an interface configured to allow the medical professional 26 to set notification settings 60 in the system 10. These notification settings 60 may allow for notifications to be sent to both to the patient user 20 while the patient user 20 is using the patient application 22 and to the medical professional user 26 while the medical professional user 26 is using the medical professional application 28.

For example, the medical professional user 26 may require a notification to be sent by the server 12 to both the medical professional user 26 (through the medical professional application 28) and the patient user 20 (through the patient application 22) if it is determined that the patient user 20 provides an actual biological level that is outside the biological target range set by the medical professional 26. In another embodiment, the medical professional 26 may require a similar notification if a plurality (i.e. 2, 3, 4, 5, etc.) measurements are taken that are outside the target range. In other embodiments, the medical professional user 26 may configure the system 10 to send a notification when a patient user 20 does not provide biological information in accordance with a prescription recommendation schedule 58 set by the medical professional user 26.

In another embodiment, the medical professional application 22 may be configured to allow the medical professional user 26 to enter a manual notification to be received by the patient user 20 when the patient user 20 logs into the patient application 22. The server 12 and/or processor 16 may be configured to receive the manual notification and send the manual notification to the patient device 18 and/or the patient application 22. The server 12 and/or processor 16 may be configured to notify the medical professional user 26 when the patient user acknowledges having received the manual notification. The patient application 22, similarly, may require the patient user to acknowledge receiving the manual notification.

Various notification settings are contemplated. It should be understood that notifications may come in the form of a push notification in some embodiments where the patient device 18 and medical professional device 24 allows for push notifications. In other embodiments, the user 20, 26 may be required to actively log into the application 22, 28 to receive a notification.

Using the notification settings set by the medical professional user 26, the processor 16 may be configured to perform a comparison of the biometric information 39 entered by the patient user 20 and the recommendation information 58, 60, 62 entered by the medical professional user. The processor 16 may be configured to determine if a notification is necessary based on the comparison of the biometric information 39 (or lack thereof in the event that the patient user 20 fails to provide biometric information on the schedule prescribed by the medical professional user 26) and the recommendation information 58, 60, 62. The server 12 may be configured to send a notification to at least one of the patient device 18 and the medical professional device 24 in the event that the processor 16 determines that a notification is necessary. The processor 16 may make the determination of when to send a notification using the input provided by the notification recommendations 60 provided by the medical professional user 26.

In one embodiment, the processor 16 may be configured to determine whether the patient user 20 meets or otherwise complies with a scheduling target for taking measurements provided for in the prescription recommendation 58. The server 12 and/or the processor 16 may be configured to send a notification to at least one of the patient device 18 and/or the medical professional device 24 if the processor 16 determines that the patient user 20 has not met or otherwise complied the target for taking measurements.

In another embodiment, the processor 16 may be configured to determine whether an actual biometric level of the biometric information 39 is outside of the target biometric range recommendation 62. The server 12 and/or processor 16 may be configured to send a notification to at least one of the patient device 18 and/or the medical professional device 24 is the processor 16 determines that the patient user 20 has provided a biometric level that is outside the target biometric range recommendation 62.

In one exemplary embodiment, the processor 16 and/or the server 12 may be configured to send a biometric measurement request notification to the patient user 20 if, for example, it is determined by the processor 16, that the patient user 20 has not fulfilled a prescription recommendation 58 set forth by the medical professional user 26. The biometric measurement request notification may be configured to request for the patient user 20 to take a biometric measurement and provide biometric information 39 relative to the biometric measurement to the server 12 and/or processor 16. The processor 16 and/or server 12 may be configured to notify the medical professional user 26, via the medical professional application 28, when the patient user 20 acknowledges having receive the biometric measurement request notification. Records of this request notification and the patient response may be retained in the patient record 42 and may be accessible by the medical professional user 26.

In another exemplary embodiment, the at server 12 and/or processor 16 may be configured to send a medication reminder notification to the patient user 20 if, for example, it is determined by the processor 16 that the patient user 20 has not acknowledged taking medication in accordance with the prescription recommendation 58 set forth by the medical professional user 26. The medication reminder notification may be configured to request for the patient user 20 to take medication. The server 12 and/or processor 16 may be configured to notify the medical professional user 26 when the patient user 20 acknowledges having received the medication reminder notification. Records of this medication reminder notification and the patient response may be retained in the patient record 42 and may be accessible by the medical professional user 26.

In other embodiments, the patient user 20 may provide notification recommendations (not shown). In this embodiment, the patient user 20 may, for example, add additional notification settings that the patient user 20 would like to receive, even if these notification settings are not required by or endorsed by the medical professional user 26.

The database 14 and/or the server 12 may be configured to store the recommendation information 58, 60, 62 in the patient record 42, as shown in FIG. 2. Each individual patient user that is using the system for managing a condition 10 may include their own individualized and stored recommendation information 58, 60, 62 which provides notifications to the medical professional user and/or patient user specifically set up by the medical professional user for the patient user. The recommendation information 58, 60, 62 may be edited by the medical professional user 26 over time as needed. The patient application 22 may be configured to allow the patient user 20 to access the recommendation information 58, 60, 62 specific to and associated with the patient record 42 of the patient user 20.

Additionally, the server 12 may be configured to retain a notification record 80 of all notifications (either manual or automatic) that have actually been sent by the server 12 and/or processor 16. This notification record 80 may be stored in the patient record 42 for the patient user 20. The server 12 may be configured to maintain the record of any notification such that the notification record is accessible to the medical professional user 26 and/or the patient user 20. When the patient user 20 responds by acknowledging a notification, this acknowledgement may also be recorded, retained or otherwise saved in the notification record 80.

Referring back to FIG. 1, the database 14 may further include clinical guideline information 44 stored therein. The clinical guideline information 44 may include information relating to best practices regarding treatment of various medical conditions, and may further include information relating to desirable biometric levels and/or ranges that individuals having those medical conditions should strive to achieve. This clinical guideline information 44 may be updated at the back end on a regular basis in order to maintain up-to-date standards according to the consensus in the medical community. For example, it may be considered good medical practice for individuals with hypertension to take their blood pressure at predetermined regular intervals. The clinical guideline information 44 may store the particular desired interval (or interval range).

The clinical guideline information 44 may be used by the processor 16 to determine whether a medical professional recommendation 64 and/or alert 66 is necessary based on a comparison of the biometric information 39, the recommendation information 58, 60, 62, and the clinical guideline information 44. The server 12 may be configured to send a medical professional recommendation 64, for example, to the medical professional device 24 if, for example, the recommendation information from the medical professional 26 is not consistent with the clinical guideline information 44. This may come in the form of a notification to the medical professional device 24 and/or application 28. The medical professional recommendation 64 may thereby be configured to notify the medical professional 26 of current best practice. The database 14 may be configured to store the medical professional recommendation 64 in the patient record 42. The medical professional application 28 and/or the patient application 22 may be provided with access to the medical professional recommendation 64 via a notification or through another interface within the application 28, 22 for reviewing medical professional recommendations 64. In response to receiving or reviewing the medical professional recommendation 64, the medical professional application 28 may allow for the medical professional user 20 to update the recommendation information 58, 60, 62 accordingly.

In a further embodiment, the medical professional user 26 and/or the patient user 20 may enter general patient information 90 into the patient record. This general patient information 90 may include information related to the general characteristics of the patient user, such as age, sex, weight, height, and the medical conditions that the patient user 20 has been diagnosed with. This general patient information 90 may be used in conjunction with the clinical guideline information 44 in order to process more accurate medical professional recommendations 64 by the processor 16.

Referring back to FIG. 2, the processor 16, the patient device 18 (via the patient application 22) and the medical professional device 24 (via the medical professional application 34) may be configured to send and receive information to and from the patient record 42 in accordance with the embodiments described herein. For example, the patient device may send data 46 in the form of the biometric information 39 to the patient record 42. This information may be saved and/or otherwise stored in the patient record 42. The patient record may further provide data 48 back to the patient device in the form of any information requested by the patient device that is stored in the patient record 42. Similarly, the medical professional device 24 may send data 50 in the form of the recommendation information 58, 60, 62, for example, to the patient record 42. This information may be saved and/or otherwise stored in the patient record 42. The medical professional device 24 may further receive data 52 from the patient record 42 in the form, for example of the biometric information 39 provided by the patient user 20. Similarly, the processor may send data 54 in the form of alerts 66 and recommendations 64 generated by the clinical guideline information and/or notification recommendations 60 set forth by the medical professional user 24. The processor receives data 56 in the form, for example, of the biological information 39, or the recommendation information 58, 60, 62 for processing and comparing with clinical guideline information 44 and the notification recommendations 60 set forth by the medical professional user 24.

Referring back to FIG. 1, the system 10 may further include the administrator device 30, administrator application 34 and customer support user 32. The administrator and/or customer support user 32 may be used to facilitate customer support for the patient user 20 and the medical professional user 26. The database 14 may include a location for storing permission information associated with the customer support user 32. This permission relationship may be similar to the embodiment shown in FIG. 3. Thus, in one embodiment, no customer support user 32 may be provided access to the patient record 42 without first obtaining permission from the patient user 20.

As described hereinabove, the server 12, processor 16, and database 14 may each be a plurality of separate servers, processors, and databases connected to perform the above-described functionality. Referring to FIG. 4, the server 12 is shown in accordance in accordance with one such embodiment having multiple computing devices or servers. In this embodiment, the server 12 may be a cloud computing platform. The server 12 may include a back end layer 74, a data access abstraction layer 84, a queuing and processing layer 86, a web server layer 92 including a patent application UI API server 94a, a medical professional UI API server 94b, and a administrator UI API server 94c, and load balancing 96. The back end layer 74 may further include at least one relational database management system 80, such as a plurality of SQL servers which may include, for example, at least one master and a plurality of slaves. The back end layer 74 may further include the capabilities for processing instances 78, a customer relationship management system 82, and a file storage location 76 such as an online file storage location. For example, the file storage location 76 may be an online file storage web service such as Amazon S3 ® in one embodiment. Still further, the back end layer 74 may include a push notification service configured to provide push notifications to users.

The data access abstraction layer 84 may allow the web servers 94a, 94b, 94c of the web server layer 92 to access the back end layer 74 and may thereby facilitate interaction and data transfer to and from the devices 18, 24, 30 to the back end layer 74. Additionally, the data access abstraction layer 84 may unify communication between the web servers 94a, 94b, 94c and the back end layer 74. Additionally, the queuing and processing layer 86 may facilitate interaction between the web servers 94a, 94b, 94c and the back end layer 74 and may include que processors 88 and a queue 90. Overall the cloud computing platform, or the server 12, may be connected to the internet 36 as depicted, and thereby to the other devices 18, 24, 30 of the system.

The condition management system 10 and/or elements of the condition management system 10 such as the patient device 18, the medical professional device 28, the administrator device 30, and the respective applications 22, 28, 34 may be operable despite not being connected to the internet 36 and/or the server 12. For example, the patient device 18 and the patient application 22 may allow the patient user 20 to input biometric information into local storage in the device 18 which may be retained by the patient device 22. The patient device 22 may retain this information and then the patient application 22, for example, may be configured to then send this information to the server 12 once the patient device 22 is connected to the internet 36. Similarly, the functionality and data input collected by the medical professional application 28 described herein may be stored locally on the medical professional device 24 if the medical professional device 24 is not connected to the internet 36. It should be understood that all of the functionality described herein that does not require the internet 36 may be performed by the respective devices and applications while those devices are not connected to the internet.

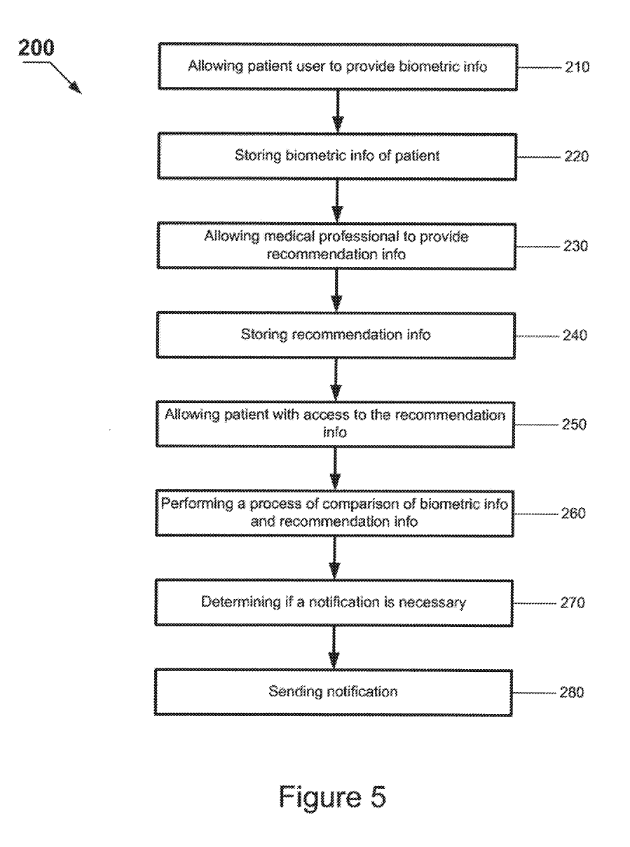

Referring now to FIG. 5, a flowchart is shown detailing a method for monitoring a condition of a patient 200. Each of the steps of the method 200 of FIG. 5 may be enabled and executed in any order by a computer processor executing computer code. Further, other embodiments contemplated herein may not include each and every step provided by the method 200 and it should be understood that this method is simply exemplary. The method 200 may include providing some or all of the computers and/or devices described hereinabove, in the manner described hereinabove, such as the server 12, the database 14, the processor 16, the patient device 18, the medical professional device 24, the administrator device 30, and the information gathering device 38. Step 210 includes allowing, for example by the patient application 22 running on the patient device 18, a patient user, such as the patient user 20, to provide biometric information, such as the biometric information 39, related to a medical condition of the patient to a patient record, such as the patient record 42, of a database, such as the database 14. Step 220 includes providing, for example by the medical professional application 28 running on the medical professional device 24, a medical professional user, such as the medical professional user 26, with access to the biometric information. Step 230 includes allowing, by for example the medical professional application 28 running on the medical professional device 24, the medical professional user to provide recommendation information, such as recommendation information 58, 60, 62, related to a patient recommendation for the patient user to the patient record. Step 240 includes storing, by for example the database 14 and/or the server 12, the provided recommendation information in the patient record. Step 250 includes allowing, by the patient application 22 for example, the patient user to access the recommendation information. Step 260 includes performing, by for example the processor 16 running on the server 12, a comparison of the patient related information and the recommendation information. Step 270 includes determining, by for example the processor 16, whether a notification is necessary based on a comparison of the patient information and the recommendation information. Step 280 further includes sending, by the server 12 for example, the notification to at least one of the patient device and the medical professional device if it is determined that the notification is necessary.

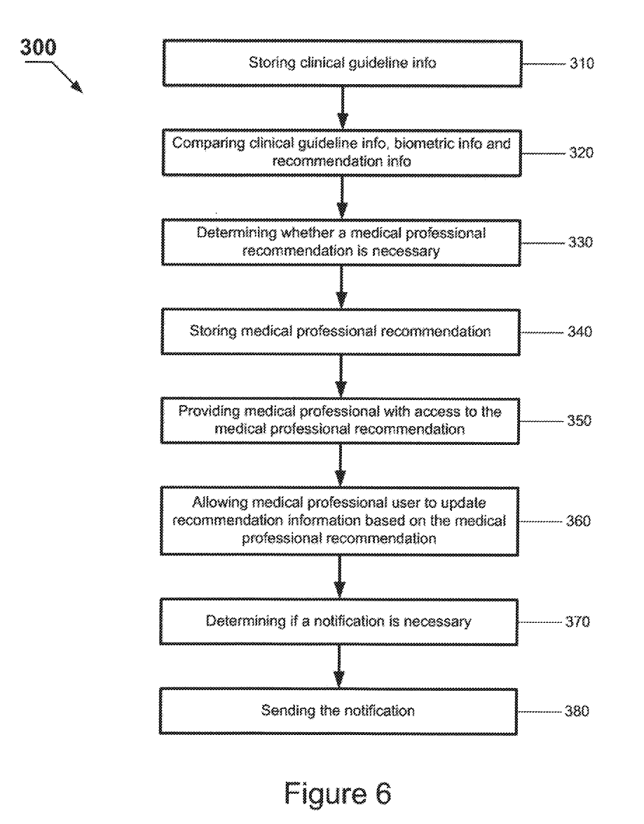

Referring now to FIG. 6, a flowchart is shown detailing a method for monitoring a condition of a patient 300. Each of the steps of the method 300 of FIG. 6 may be enabled and executed in any order by a computer processor executing computer code. Further, other embodiments contemplated herein may not include each and every step provided by the method 300 and it should be understood that this method is simply exemplary. Like the method 200, the method 300 may include providing some or all of the computers and/or devices described hereinabove, in the manner described hereinabove, such as the server 12, the database 14, the processor 16, the patient device 18, the medical professional device 24, the administrator device 30, and the information gathering device 38. Step 310 of the method 300 includes storing clinical guideline information, such as the clinical guideline information 44, into a database, such as the database 14. Step 320 includes comparing, by the processor 16 for example, a the biometric information, such as the biometric information 39, recommendation information, such as the recommendation information 58, 60, 62, and the clinical guideline information. Step 330 includes determining, by the processor 16 for example, whether a medical professional recommendation, such as the recommendation 64 based on the comparison. Step 340 includes storing, by the database 14 for example, the medical professional recommendation in a patient record, such as the patient record 42. Step 350 includes providing, by the medical professional application 28 for example, a medical professional user, such as the medical professional user 26, with access to the medical professional recommendation. Step 360 includes allowing, by the medical professional application 28 for example, the medical professional user to update the recommendation information. Step 370 includes determining, by the one processor 16 for example, whether a notification is necessary based on the medical professional recommendation. Step 380 includes sending, by the processor 16 for example, the notification to a medical professional device, such as the medical professional device 24, if it is determined that the notification is necessary.

While not shown specifically, in FIGS. 5 and 6, the methods 200 and/or 300 may further include additional steps. For example, methods contemplated may include providing a location in the database, such as the location shown in FIG. 3, for storing permission information associated with the patient user and the doctor user. The methods contemplated may include determining, by the processor 16 using the permission information 40 for example, whether the patient user has access to the recommendation information. The methods contemplated may further include determining, by for example the processor 16 using the permission information 40, whether the medical professional user has access to the biometric information. The methods contemplated may include providing, by for example the patient application 22, the patient user with control over whether any other user (such as the medical professional user 26 or the customer support user 32) has access to the biometric information.

Methods may include determining, by the processor 16 for example, whether an actual biometric level of provided biometric information is not within a target biometric range of provided recommendation information, and sending, for example by the server 12, a notification to at least one of the patient device and the doctor device if it is determined that the actual biometric level is not within the target biometric range.

Methods may include determining, by the processor 16 for example, whether the patient user meets a target for taking measurements provided for in the recommendation information and sending, by for example the server 12, the notification to at least one of the patient device and the doctor device if the processor determines that the patient user has not met the target for taking measurements.

Methods may include retaining, by the server 12 for example, a record of the notification in the patient record, and wherein the server is configured to have the record of the notification in the patient record accessible to the medical professional user.

Methods may include allowing, by the medical professional application 28 for example, the medical professional user to enter a manual notification to be received by the patient user. Methods may include receiving, by the server 12 for example, the manual notification. Methods may include sending, by the server 12 for example, the manual notification to the patient device. Methods may include notifying, by the server 12 for example, the medical professional user when the patient user acknowledges having received the manual notification. Methods may include retaining, by the server 12 for example, a record of the manual notification in the patient record. Methods may include maintaining, by the server 12 for example, the record of the manual notification in the patient record accessible to the medical professional user.

Methods may include providing an information gathering device such as the information gathering device 38, and obtaining, with the information gathering device, biometric information from the patient user and facilitating in providing, by the information gathering device 38 for example, the biometric information to the server.

Methods may include sending, by the server 12 for example, a biometric measurement request notification to the patient user. Methods may include requesting, with the biometric measurement request notification, for the patient user to take a biometric measurement and provide biometric information relative to the biometric measurement to the server. Methods may include notifying, by the server 12 for example, the medical professional user when the patient user acknowledges having received the biometric measurement request notification. Methods may include retaining a record of the biometric measurement request, by the server 12 for example, in the patient record and maintaining the record of the biometric measurement request, by the server 12 for example, in the patient record accessible to the medical professional user.

Methods may include sending, by the server 12 for example, a medication reminder notification to the patient user and requesting, with the medication reminder notification, for the patient user to take medication. Methods may include notifying, with the sever 12 for example, the medical professional user when the patient user acknowledges having received the medication reminder notification. Methods may further include retaining, by the server 12 for example, a record of the medication reminder notification in the patient record. Methods may include maintaining a record, by the server 12 for example, the record of the biometric measurement request in the patient record accessible to the medical professional user.

Methods may further include providing an administrator device, such as the administrator device 30, in operable communication with a server such as the server 12 for example, the administrator device including an administrator application for a customer support user. Methods may include providing a location in a database for storing permission information associated with the customer support user. Methods may include determining, by the processor 16, for example, using the permission information, whether the customer support user has access to the recommendation information. Methods may include determining, by the processor 16, for example, using the permission information, whether the customer support user has access to the biometric information.

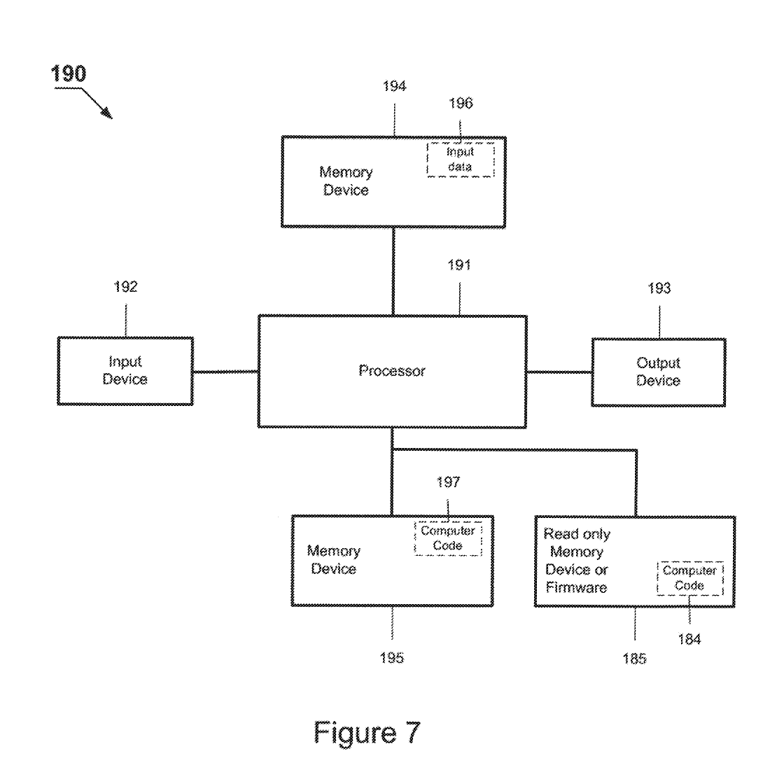

FIG. 7 illustrates a computer system 190 (e.g., the server 12, the patient device 18, the medical professional device 24, the administrator device 30 and the information gathering device 38 FIG. 1) for enabling a method of monitoring a medical condition of a patient, in accordance with embodiments of the present invention.

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a solid state drive (SDD), a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing apparatus receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, device (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing device to produce a machine, such that the instructions, which execute via the processor of the computer or other programmable data processing device, create means for implementing the functions/acts specified in the flowchart and/or block diagram block or blocks. These computer readable program instructions may also be stored in a computer readable storage medium that can direct a computer, a programmable data processing device, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing device, or other device to cause a series of operational steps to be performed on the computer, other programmable device or other device to produce a computer implemented process, such that the instructions which execute on the computer, other programmable device, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The computer system 190 illustrated in FIG. 7 includes a processor 191, an input device 192 coupled to the processor 191, an output device 193 coupled to the processor 191, and memory devices 194 and 195 each coupled to the processor 191. The input device 192 may be, inter alia, a keyboard, a mouse, a camera, a touchscreen, etc. The output device 193 may be, inter alia, a printer, a plotter, a computer screen, a magnetic tape, a removable hard disk, a floppy disk, etc. The memory devices 194 and 195 may be, inter alia, a hard disk, a floppy disk, a magnetic tape, an optical storage such as a compact disc (CD) or a digital video disc (DVD), a dynamic random access memory (DRAM), a read-only memory (ROM), etc. The memory device 195 includes a computer code 197. The computer code 197 includes algorithms (e.g., the algorithm of FIGS. 5 and 6) for enabling a method of monitoring a medical condition of a patient. The processor 191 executes the computer code 197. The memory device 194 includes input data 196. The input data 196 includes input required by the computer code 197. The output device 193 displays output from the computer code 197. Either or both memory devices 194 and 195 (or one or more additional memory devices such as read only memory device 196) may include the algorithms of FIGS. 5 and 6 (or the other algorithms described herein) and may be used as a computer usable medium (or a computer readable medium or a program storage device) having a computer readable program code embodied therein and/or having other data stored therein, wherein the computer readable program code includes the computer code 197. Generally, a computer program product (or, alternatively, an article of manufacture) of the computer system 190 may include the computer usable medium (or the program storage device).

In some embodiments, rather than being stored and accessed from a hard drive, optical disc or other writeable, rewriteable, or removable hardware memory device 195, stored computer program code 184 (e.g., including the algorithms of FIGS. 5 and 6) may be stored on a static, nonremovable, read-only storage medium such as a Read-Only Memory (ROM) device 185, or may be accessed by processor 191 directly from such a static, nonremovable, read-only medium 185. Similarly, in some embodiments, stored computer program code 184 may be stored as computer-readable firmware 185, or may be accessed by processor 191 directly from such firmware 185, rather than from a more dynamic or removable hardware data-storage device 195, such as a hard drive or optical disc.

Still yet, any of the components of the present invention could be created, integrated, hosted, maintained, deployed, managed, serviced, etc. by a service supplier who offers to enable a method of monitoring a medical condition of a patient. Thus the present invention discloses a process for deploying, creating, integrating, hosting, maintaining, and/or integrating computing infrastructure, including integrating computer-readable code into the computer system 190, wherein the code in combination with the computer system 190 is capable of performing a method of monitoring a medical condition of a patient. In another embodiment, the invention provides a business method that performs the process steps of the invention on a subscription, advertising, and/or fee basis. That is, a service supplier, such as a Solution Integrator, could offer to enable a method of monitoring a medical condition of a patient. In this case, the service supplier can create, maintain, support, etc. a computer infrastructure that performs the process steps of the invention for one or more customers. In return, the service supplier can receive payment from the customer(s) under a subscription and/or fee agreement and/or the service supplier can receive payment from the sale of advertising content to one or more third parties.

While FIG. 7 shows the computer system 190 as a particular configuration of hardware and software, any configuration of hardware and software, as would be known to a person of ordinary skill in the art, may be utilized for the purposes stated supra in conjunction with the particular computer system 190 of FIG. 7. For example, the memory devices 194 and 195 may be portions of a single memory device rather than separate memory devices.

Elements of the embodiments have been introduced with either the articles “a” or “an.” The articles are intended to mean that there are one or more of the elements. The terms “including” and “having” and their derivatives are intended to be inclusive such that there may be additional elements other than the elements listed. The conjunction “or” when used with a list of at least two terms is intended to mean any term or combination of terms. The terms “first” and “second” are used to distinguish elements and are not used to denote a particular order.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

I claim:

1. A medical condition management system comprising:
at least one server including:
at least one database including a patient record;
at least one processor coupled to the at least one database;
a patient device in operable communication with the at least one server, the patient device including a patient application, the patient device operable by a patient user;
a medical professional device in operable communication with the at least one server, the medical professional device including a medical professional application, the medical professional device operable by a medical professional user,
wherein the patient application is configured to allow the patient user to provide biometric information to the patient record,
wherein the at least one database is configured to store the provided biometric information in the patient record,
wherein the medical professional application is configured to provide the medical professional user with access to the biometric information,
wherein the medical professional application is configured to allow the medical professional user to provide recommendation information to the patient record,
wherein the at least one database is configured to store the provided recommendation information in the patient record,
wherein the patient application is configured to allow the patient user to access the recommendation information,
wherein the at least one processor is configured to perform a comparison of the biometric information and the recommendation information,
wherein the at least one processor is configured to determine whether a notification is necessary based on the comparison of the biometric information and the recommendation information, and
wherein the at least one server is configured to send the notification to at least one of the patient device and the medical professional device if the at least one processor determines that the notification is necessary.

2. The medical condition management system of claim 1, further comprising:
clinical guideline information stored in the at least one database;
wherein the at least one processor is configured to determine whether a medical professional recommendation is necessary based on a comparison of the biometric information, the recommendation information, and the clinical guideline information,
wherein the at least one database is configured to store the medical professional recommendation in the patient record, and
wherein the medical professional application is configured to provide the medical professional user with access to the medical professional recommendation, and
wherein the medical professional application is configured to allow the medical professional user to update recommendation information related to the medical professional recommendation.

3. The medical condition management system of claim 2, wherein the at least one processor is configured to determine whether a second notification is necessary based on the medical professional recommendation, and
wherein the at least one processor is configured to send the second notification to the medical professional device if the at least one processor determines that the second notification is necessary.

4. The medical condition management system of claim 1, wherein the at least one database includes a location for storing permission information, wherein the permission information determines whether the patient user has access to the recommendation information, and wherein the permission information determines whether the doctor user has access to the biometric information.

5. The medical condition management system of claim 4, wherein the patient application is configured to provide the patient user with control over whether any other user has access to patient record.

6. The medical condition management system of claim 1, wherein the at least one processor is configured to determine whether an actual biometric level of the biometric information is outside a target biometric range provided for in the recommendation information, and wherein the at least one server is configured to send the notification to at least one of the patient device and the medical professional device if the at least one processor determines that the actual biometric level is not within the target biometric range.

7. The medical condition management system of claim 1, wherein the recommendation information includes a scheduling target for taking measurements, by the patient user, to gather an actual biometric level, and wherein the at least one processor is configured to determine whether the patient user meets the scheduling target, and wherein the at least one server is configured to send the notification to at least one of the patient device and the medical professional device if the at least one processor determines that the patient user has not met the scheduling target.

8. The medical condition management system of claim 1, wherein the biometric information includes actual biometric levels selected from the group consisting of blood pressure levels, body temperature levels, weight levels, heart rate levels, glucose levels, spirometry levels, and sleep duration levels, and wherein the recommendation information includes target biometric ranges selected from the group consisting of blood pressure ranges, body temperature ranges, weight ranges, heart rate ranges, glucose level ranges, spirometry level ranges, and sleep duration ranges.

9. The medical condition management system of claim 1, wherein the at least one server is configured to retain a record of the notification in the patient record, and wherein the at least one server is configured to maintain the record of the notification in the patient record so that the record of the notification is accessible to the medical professional user.

10. The medical condition management system of claim 1, wherein the medical professional application is configured to allow the medical professional user to enter a manual notification to be received by the patient user, wherein the at least one server is configured to receive the manual notification and send the manual notification to the patient device.

11. The medical condition management system of claim 10, wherein the at least one server is configured to notify the medical professional user when the patient user acknowledges having received the manual notification.

12. The medical condition management system of claim 11, wherein the at least one server is configured to retain a record of the manual notification in the patient record, and wherein the at least one server is configured to maintain the record of the manual notification in the patient record such that the record of the manual notification is accessible to the medical professional user.

13. The medical condition management system of claim 1, further comprising an information gathering device configured to obtain the biometric information from the patient user and facilitate in providing the biometric information to the at least one server.

14. The medical condition management system of claim 13, wherein the information gathering device is a device selected from the group consisting of a scale, a blood pressure measuring device, a glucose measuring device, a sleep measuring device, a heart monitoring device, a lung function measuring device, and a wearable device.

15. The medical condition management system of claim 1, wherein the at least one sever is configured to send a biometric measurement request notification to the patient user, wherein the biometric measurement request notification is configured to request for the patient user to take a biometric measurement and provide biometric information relative to the biometric measurement to the at least one server, and wherein the at least one server is configured to notify the medical professional user when the patient user acknowledges having received the biometric measurement request notification.

16. The medical condition management system of claim 15, wherein the at least one server is configured to retain a record of the biometric measurement request in the patient record, and wherein the at least one server is configured to maintain the record of the biometric measurement request in the patient record such that the record of the biometric measurement request is accessible to the medical professional user.

17. The medical condition management system of claim 1, wherein the at least one server is configured to send a medication reminder notification to the patient user, wherein the medication reminder notification is configured to request for the patient user to take medication, and wherein the at least one database is configured to notify the medical professional user when the patient user acknowledges having received the medication reminder notification, wherein the at least one server is configured to retain a record of the medication reminder notification in the patient record, and wherein the at least one server is configured to maintain the record of the biometric measurement request in the patient record such that the record of the medication reminder notification is accessible to the medical professional user.

18. The medical condition management system of claim 1, further comprising an administrator device in operable communication with the at least one sever, the administrator device including an administrator application, the administrator device operable by a customer support user, wherein the at least one database includes a location for storing permission information associated with the customer support user, wherein the permission information determines whether the customer support user has access to the recommendation information provided by the medical professional user, and wherein the permission information determines whether the customer support user has access to the biometric information provided by the patient user.

19. A method of managing a medical condition of a patient comprising:
providing a medical condition management system including:
at least one server including:
at least one database including a patient record;
at least one processor coupled to the at least one database;
a patient device in operable communication with the at least one server, the patient device including a patient application, the patient device operable by a patient user;
a medical professional device in operable communication with the at least one server, the medical professional device including a medical professional application, the medical professional device operable by a medical professional user;
allowing, by the patient application, the patient user to provide biometric information to the patient record;
storing, by the at least one database, the provided biometric information in the patient record;
providing, by the medical professional application, the medical professional user with access to the biometric information;
allowing, by the medical professional application, the medical professional user to provide recommendation information to the patient record;
storing, by the at least one database, the provided recommendation information in the patient record;
allowing, by the patient application, the patient user to access the recommendation information;
performing, by the at least one processor, a comparison of the biometric information and the recommendation information;
determining, by the at least one processor, whether a notification is necessary based on the comparison of the biometric information and the recommendation information; and
sending, by the at least one server, the notification to at least one of the patient device and the medical professional device if the at least one processor determines that the notification is necessary.

20. The method of managing a medical condition of a patient of claim 19, further comprising:
storing clinical guideline information in the at least one database;
performing, by the at least one processor, a comparison of the biometric information, the recommendation information, and the clinical guideline information;
determining, by the at least one processor, whether a medical professional recommendation is necessary based on the comparison of the biometric information, the recommendation information, and the clinical guideline information;
storing, by the at least one database, the medical professional recommendation in the patient record;
providing, by the medical professional application, the medical professional user with access to the medical professional recommendation;
allowing, by the medical professional application, the medical professional user to update recommendation information related to the medical professional recommendation.

21. The method of managing a medical condition of a patient of claim 20, further comprising:
determining, by that at least one processor, whether a second notification is necessary based on the medical professional recommendation, and
sending, by the at least one processor, the second notification to the medical professional device if the at least one processor determines that the second notification is necessary.

22. The method of managing a medical condition of a patient of claim 19, further comprising:
providing a location in the at least one database for storing permission information;
determining, by the processor using the permission information, whether the patient user has access to the recommendation information; and
determining, by the processor using the permission information, whether the doctor user has access to the biometric information.

23. The method of managing a medical condition of a patient of claim 22, further comprising:
providing, by the patient application, the patient user with control over whether any other user has access to the biometric information.

24. The method of managing a medical condition of a patient of claim 19, further comprising:
determining, by the at least one processor, whether an actual biometric level of the biometric information is outside a target biometric range provided for in the recommendation information; and
sending, by the at least one server, the notification to at least one of the patient device and the doctor device if the at least one processor determines that the actual biometric level is outside the target biometric range.

25. The method of managing a medical condition of a patient of claim 19, wherein the recommendation information includes a scheduling target for taking measurements, by the patient user, to provide the biometric information, the method further comprising:
determining, by the at least one processor, whether the patient user meets the scheduling target;
sending, by the at least one server, the notification to at least one of the patient device and the doctor device if the at least one processor determines that the patient user has not met the scheduling target.

26. The method of managing a medical condition of a patient of claim 19, wherein the biometric information includes actual biometric levels selected from the group consisting of blood pressure levels, body temperature levels, weight levels, heart rate levels, glucose levels, spirometry levels, and sleep duration levels, and wherein the recommendation information includes target biometric ranges selected from the group consisting of blood pressure ranges, body temperature ranges, weight ranges, heart rate ranges, glucose level ranges, spirometry level ranges, and sleep duration ranges.

27. The method of managing a medical condition of a patient of claim 19, further comprising:
retaining, by the at least one server, a record of the notification in the patient record; and
maintaining, by the at least one server, the record of the notification in the patient record such that the record of the notification is accessible to the medical professional user.

28. The method of managing a medical condition of a patient of claim 19, further comprising:
allowing, by the medical professional application, the medical professional user to enter a manual notification; and
receiving, by the at least one server, the manual notification; and
sending, by the at least one server, the manual notification to the patient device.

29. The method of managing a medical condition of a patient of claim 28, further comprising:
notifying, by the at least one server, the medical professional user when the patient user acknowledges having received the manual notification.

30. The method of managing a medical condition of a patient of claim 29, further comprising:
retaining, by the at least one server, a record of the manual notification in the patient record; and
maintaining, by the at least one server, the record of the manual notification in the patient record such that the record of the manual notification is accessible to the medical professional user.

31. The method of managing a medical condition of a patient of claim 19, further comprising:
providing an information gathering device;
obtaining, with the information gathering device, biometric information from the patient user; and
facilitating in providing, by the information gathering device, the biometric information to the at least one server.

32. The method of managing a medical condition of a patient of claim 31, wherein the information gathering device is a device selected from the group consisting of a scale, a blood pressure measuring device, a glucose measuring device, a sleep measuring device, a heart monitoring device, a lung function measuring device, and a wearable device.

33. The method of managing a medical condition of a patient of claim 19, further comprising:
sending, by the at least one server, a biometric measurement request notification to the patient user;
requesting, with the biometric measurement request notification, for the patient user to take a biometric measurement and provide biometric information relative to the biometric measurement to the at least one server; and
notifying, by the at least one server, the medical professional user when the patient user acknowledges having received the biometric measurement request notification.

34. The method of managing a medical condition of a patient of claim 33, further comprising:
retaining a record of the biometric measurement request, by the at least one server, in the patient record; and
maintaining the record of the biometric measurement request by the at least one server in the patient record such that the record of the biometric measurement request is accessible to the medical professional user.

35. The method of managing a medical condition of a patient of claim 19, further comprising:
sending, by the at least one server, a medication reminder notification to the patient user;
requesting, with the medication reminder notification, for the patient user to take medication;
notifying, with the at least one sever, the medical professional user when the patient user acknowledges having received the medication reminder notification;
retaining, by the at least one server, a record of the medication reminder notification in the patient record; and
maintaining a record, by the at least one server, the record of the biometric measurement request in the patient record such that the record of the biometric measurement request is accessible to the medical professional user.

36. The method of managing a medical condition of a patient of claim 19, further comprising:
providing an administrator device in operable communication with the at least one sever, the administrator device including an administrator application operable by a customer support user;
providing a location in the at least one database for storing permission information associated with the customer support user;
determining, by the processor using the permission information, whether the customer support user has access to the recommendation information; and
determining, by the processor using the permission information, whether the customer support user has access to the biometric information.

37. A computer program product, comprising a computer readable hardware storage device storing a computer readable program code, said computer readable program code comprising an algorithm that, when executed by at least one computer processor connected to at least one database and connected to a patient device operated by a patient user and a medical professional device operated by a medical professional user, implements a method of managing a medical condition of a patient comprising:
receiving, by the at least one computer processor, biometric information related to a medical condition of the patient user from the patient device;
storing, by the at least one computer processor, the provided biometric information in a patient record of the at least one database;
providing, by the at least one computer processor, the medical professional user with access to the biometric information;
receiving, by the at least one computer processor, recommendation information related to a patient recommendation for the patient user from the medical professional device;
storing, by the at least one computer processor, the provided recommendation information in the patient record of the at least one database;
providing, by the at least one computer processor, the patient user with access the recommendation information;
performing, by the at least one computer processor, a comparison of the patient related information and the recommendation information;
determining, by the at least one computer processor, whether a notification is necessary based on the comparison of the biometric information and the recommendation information; and
sending, by the at least one computer processor, the notification to at least one of the patient device and the medical professional device if the at least one computer processor determines that the notification is necessary.
